(19) United States
(12) Patent Application Publication
(10) Pub. No.: US 2016/0333541 A1
(43) Pub. Date: Nov. 17, 2016

(54) Pyramid Pile Anchor Guide

(71) Applicant: David Murden, Lubbock, TX (US)

(72) Inventor: David Murden, Lubbock, TX (US)

(21) Appl. No.: 14/711,005

(22) Filed: May 13, 2015

(51) Int. Cl. E02D 5/54; F16M 11/00; E04H 12/22

(52) U.S. Cl. CPC E02D 5/54; E04H 12/2238; F16M 11/00

(57) ABSTRACT

The present disclosure is directed to a tetrahedron-pyramid pile anchor guide. The anchor guide includes an upper base plate (which is optionally triangular), a triangular lower base, and three tubulars permanently affixed to the upper base and the lower base at fixed angles, thereby maintaining the upper base and lower base in fixed relative positions, each tubular configured to receive a driven tubular anchor rod.

### BACKGROUND

Many applications exist for ground anchoring devices, including for load bearing in building, whether temporary or permanent, to hobbies, sports, and agriculture. For example, ground anchoring devices are used for building pier and beam foundations, to support for lighter weight structures such as fence posts, decorative garden structures or shade structures, sports equipment, camping gear, camera and lighting equipment, signage, pet leash tie-offs, and more. Various anchoring devices utilize a pre-cast cement or concrete anchor rod guide, however, the cost of shipping such heavy material makes such devices inappropriate for many applications in many environments where a cement truck is unavailable or pouring a cement slab foundation is unadvisable. Construction techniques for load bearing and load transferring may take into account low environmental impact, economic construction and shipping, and materials that are low cost, easy to work with and ship, and resilient to oxidation and decay in many types of environments, which can be used without alteration or preparation of the soil where installed.

### SUMMARY

In at least one aspect, the disclosure relates to a tetrahedron-pyramid pile anchor guide. The anchor guide includes an upper base plate, a triangular or hexagonal lower base, and three tubulars permanently affixed to the upper base and the lower base at fixed angles, thereby maintaining the upper base and lower base in fixed relative positions, each tubular configured to receive a driven tubular anchor rod.

In at least one aspect, the disclosure relates to a pier anchoring structure kit. The kit includes a tetrahedron-pyramid pile anchor guide as described in paragraph [0002], and three tubular anchor rods.

In at least one aspect, the disclosure relates to a structure having a foundation. The foundation includes a plurality of tetrahedron-pyramid shaped pile anchor guide anchors secured in a pattern on a building site by at least 3 tubular anchor rods per tetrahedron-pyramid shaped pile guide anchor as described above. The tubular anchor rods are secured in place once driven into the ground through the pile guide anchors by hardware. The foundation also includes load-bearing supports affixed to mounting hardware on each pile guide anchor.

In at least one aspect, the disclosure relates to a tetrahedron-pyramid shaped guide anchor to secure an item in a fixed yet removable position anchored to the Earth. The guide anchor includes an upper base, optionally having an aperture therethrough. The guide anchor includes a triangular lower base, optionally having an aperture therethrough. The guide anchor includes three tubulars permanently affixed to the upper base and the lower base at fixed angles, thereby maintaining the upper base and lower base in fixed relative positions, each tubular configured to receive an anchor rod. The guide anchor includes hardware affixed to the upper base configured to receive a portion of the item that is to be anchored to the Earth.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Embodiments of systems, apparatuses, and methods for load bearing support structure based on an environmentally friendly concrete free tetrahedron-pyramid pile anchor guide are described with reference to the following figures. Like numbers are used throughout the figures to reference like features and components.

FIG. 1 is a top-down view of a first embodiment of a concrete free tetrahedron-pyramid pile anchor guide.

FIG. 2 is a side view of a second embodiment of a concrete free tetrahedron-pyramid pile anchor guide.

FIG. 3 is a side view of a third embodiment of a concrete free tetrahedron-pyramid pile anchor guide with anchor rods in place after insertion into the guide.

FIG. 4 is a side view of a more detailed embodiment of a concrete free tetrahedron-pyramid pile anchor guide with mounting hardware and removable hardware for securing anchor rods in place after insertion into the guide.

### DETAILED DESCRIPTION

In the following description, numerous details are set forth to provide an understanding of the present disclosure. However, it will be understood by those skilled in the art that the present disclosure may be practiced without these details and that numerous variations or modifications from the described embodiments are possible.

The present disclosure relates to an inexpensively manufactured, easily shippable structurally sound anchor guide that, when anchor rods are driven through the anchor guide into the ground below, is secured in position such that the anchor guide may be coupled to various loads intended to be anchored in place. For example, the anchor guide may be used to anchor structural loads, such as pier and beam foundations, bridge or road supports, boat docks, and extended to structures with lower load bearing necessity fence posts, decorative garden structures or shade structures, sports equipment, camping gear, camera and lighting equipment, signage, pet leash tie-offs, and more. The anchor guide may be positioned at the surface, with little to no excavation of the earth, and anchor rods inserted through the anchor guide into the earth. The geometry of the anchor guide of the present disclosure sets it apart from various commercially available footings: the anchor guide has an upper base, which may be triangular, a lower equilateral triangular base, and the upper and lower bases are connected together by 3 tubulars, forming a tetrahedron pyramid. In an embodiment, the material for the anchor guide may be various non-oxidizing metals, each component being welded to the others. In an embodiment, the material for the anchor guide may be any of various hard polymers, formed, for example, in an injection or extrusion mold.

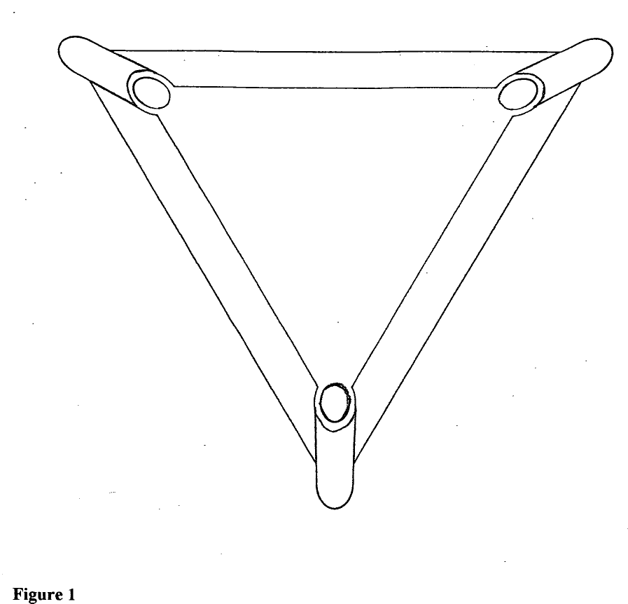

FIG. 1 is a top-down view of a first embodiment of a concrete free tetrahedron-pyramid pile anchor guide. As can be seen with reference to FIG. 1, the anchor guide is a tetrahedron pyramid having an equilateral triangle as a lower base, and three equilateral triangular faces meeting at a top point. An upper base plate is attached at the top point, resulting in the equilateral triangular base parallel with the upper base plate. In an embodiment, the edges coupling between the upper base plate and the triangular lower base are tubulars, such as steel galvanized piping. In an embodiment, the tubulars are welded to the upper base plate and the triangular lower base, also made of galvanized steel, into fixed angles. In an embodiment, the triangular lower base may be a solid plate, or three pieces fastened together.

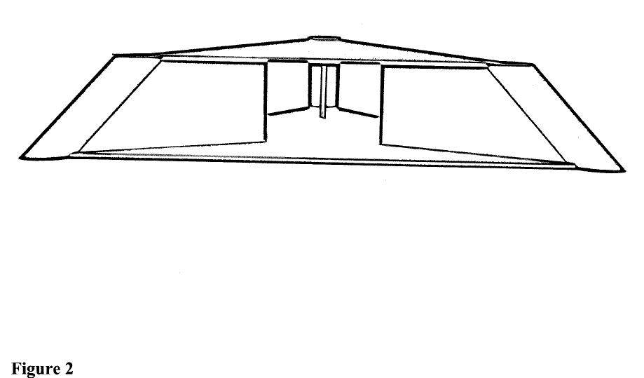

FIG. 2 is a side view of a second embodiment of a concrete free tetrahedron-pyramid pile anchor guide. As shown in FIG. 2, the tubulars are more clearly shown as tubular in nature. When the anchor guide is used, the lower triangular base is place substantially parallel with the ground. An anchor rod, preferably tubular as well, is driven into each of the edge tubulars coupling between the upper base plate and the lower triangular base. The edge tubulars held at fixed angles by virtue of being welded to the upper base plate and the lower triangular bas guides the anchor rods driven into the ground at the desired angle to secure the anchor guide to the ground without any prior preparation of the earth. When the anchor rods are driven into the ground, the anchor guide is secured permanently in place in a fashion that is resistant to heave due to temperature changes and any shifting in the ground.

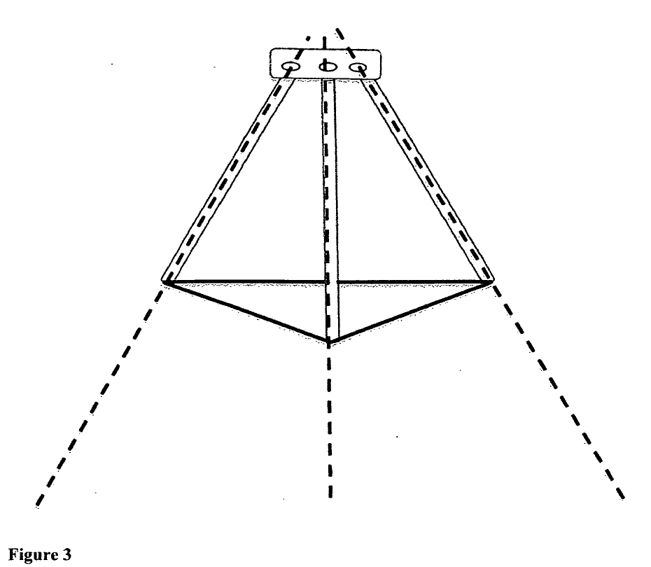

FIG. 3 is a side view of a third embodiment of a concrete free tetrahedron-pyramid pile anchor guide with anchor rods in place after insertion into the guide. The dashed lines represent the anchor rods. As can be seen looking at FIG. 3, the tubulars welded to the upper base plate result in at least 3 openings in the upper base plate where the anchor rods be may inserted into the tubulars, and driven into the ground below using a driving mechanism, such as an impact drill, sledge hammer or other tools commonly used in the art to install anchor rods. The fixed angles of the tubulars relative to the vertical reference plane running from top to bottom of the anchor guide may be selected for the known characteristics of the ground, frost line characteristics, the depth to which anchor rods will need to be driven to withstand weather conditions, and the like.

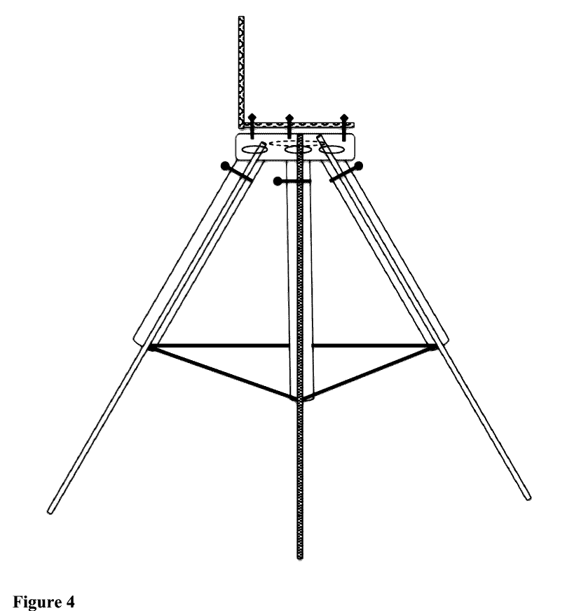

FIG. 4 is a side view of a more detailed embodiment of a concrete free tetrahedron-pyramid pile anchor guide with mounting hardware and removable hardware for securing anchor rods in place after insertion into the guide. When the tubular anchor rods are driven into the ground, the driving force causes earth to fill the interior of the tubular anchor rods, providing additional strength and resistance to shifting ground or heave due to temperature changes. Features that are additionally shown in FIG. 4 that were not shown in FIGS. 1-3 include an aperture through the upper base plate, mounting hardware affixed to the upper base plate, and removable hardware for securing the tubular anchor rods in place. The aperture through the upper base plate enables items desired by the user to be secured to the ground to be placed through the aperture and secured in place. For example, a shade umbrella or camera unipod stem may be inserted through the aperture in the upper base plate of the anchor guide and held securely in place.

The mounting hardware that is affixed to the upper base plate is shown here as an L-bracket, however, any bracket shape or hardware (such as u-bracket, metal structural braces, anchor bolts, post base, etc.) may be used. As shown, the L bracket is secured to the upper base plate via bolts, and bolts to the upper arm of the L bracket may secure pier beams.

Also shown in FIG. 4 is removable hardware removable hardware that secures each tubular anchor rod in a fixed position when the tubular anchor rod is driven into place within any one of the three tubulars of the pile anchor guide. In an embodiment, the removable hardware is configured for insertion at an angle perpendicular to the angle at which the tubular anchor rod is driven into the ground.

### Example 1

### Footing for Pier and Beam Foundation

In a first commercial embodiment, the anchor guide described above is used as a surface positioned footing for a pier and beam foundation. In such an embodiment, the upper base, lower base, and tubulars are made of galvanized steel, and the anchor guide is substantially free of concrete or cement. The lower base is an equilateral triangle, each angle being 60 degrees. Each side face (having two tubulars and an edge of the lower base) is also an equilateral triangle, however, additional angles and non-equilateral triangular faces are also contemplated at this time, as the angle of each tubular relative to vertical may vary based on frost depth, soil type, length of anchor rod, anticipated foundation component spacing, based on the proposed structure's configuration, width, height above grade, building materials to be supported, and potential load combinations. Each anchor rod is a hollow rod, having an outer diameter of less than 3 inches, such that each anchor rod can be inserted through the respective tubulars of the anchor guide into the earth. The anchor rods may be, for example, to be at minimum, Schedule 40 galvanized steel pipe with butt cut driving ends. Driving the anchor rods through the anchor guide using, for example, an impact drill or sledge hammer, forces earth into the inner diameter of each anchor rod, and when the anchor rods are driven to depth, a pin, screw, or other removable hardware may be inserted to maintain the anchor rod at such position relative to the anchor guide. Mounting hardware is attached to the upper base of the anchor guide, such as an L bracket, U bracket, or other brace to which beams may be attached. By positioning anchor guides secured with anchor rods anywhere from 3 feet to 12 feet apart, and preferably about 6 feet to 8 feet apart, a structurally sound construction is achievable.

### Example 2

### Secure but Removable Anchor for Outdoor Umbrella

In a second embodiment, the anchor guide described above is used as a surface positioned anchor for an outdoor umbrella. In such an embodiment, the upper base, lower base, and tubulars may be made of a plastic or polymer that is lightweight and easy to move or ship, and the anchor guide is substantially free of concrete or cement. Alternatively, the components of the anchor guide may be made of a galvanized or painted metal. The upper base and lower base each have an aperture therethrough enabling an umbrella pole to be inserted. The mounting hardware may include a clamping or locking mechanism to secure the umbrella pole to the anchor guide in a desired position (for example, relative to the direction of the sun). In use, the anchor guide is positioned on the ground, and three anchor rods (i.e. pins) are inserted in the tubulars of the anchor guide at the angle ensured by the angled direction of each tubular, securing the anchor guide in position. In an embodiment, the anchor rods may include a grip or handle to enable a user to remove the anchor rods and remove the anchor guide when the umbrella is no longer in use.

### Example 3

### Secure but Removable Anchor for Rotating Hardware Securing Pet Leash

In a third embodiment, the anchor guide described above is used as a surface positioned anchor for hardware that secures a pet leash. In such an embodiment, the upper base, lower base, and tubulars may be made of a plastic or polymer that is lightweight and easy to move or ship, and the anchor guide is substantially free of concrete or cement. Alternatively, the components of the anchor guide may be made of a galvanized or painted metal. The mounting hardware may include a rotating mechanism to which a pet leash may be attached, allowing an animal to safely roam within a diameter the length of the leash about the anchor guide. In use, the anchor guide is positioned on the ground, and three anchor rods (i.e. pins) are inserted in the tubulars of the anchor guide at the angle ensured by the angled direction of each tubular, securing the anchor guide in position. In an embodiment, the anchor rods may include a grip or handle to enable a user to remove the anchor rods and remove the anchor guide when the anchor for the pet leash is no longer in use.

Although a few example embodiments have been described in detail above, those skilled in the art will readily appreciate that many modifications are possible in the example embodiments without materially departing from this disclosure. Accordingly, such modifications are intended to be included within the scope of this disclosure as defined in the following claims. In the claims, means-plus-function clauses are intended to cover the structures described herein as performing the recited function and not simply structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A tetrahedron-pyramid pile anchor guide, comprising:
an upper base plate;
a triangular lower base;
three tubulars permanently affixed to the upper base and the lower base at fixed angles, thereby maintaining the upper base and lower base in fixed relative positions, each tubular configured to receive a driven tubular anchor rod.

2. The tetrahedron-pyramid pile anchor guide according to claim 1, wherein the triangular lower base comprises one of 1) a solid plate, 2) three tubular members or 3) other triangular perimeter portions affixed to one another.

3. The tetrahedron-pyramid pile anchor guide according to claim 1, wherein the upper base plate comprises an aperture therethrough.

4. The tetrahedron-pyramid pile anchor guide according to claim 2, wherein the triangular lower base comprises an aperture therethrough.

5. The tetrahedron-pyramid pile anchor guide according to claim 1, wherein the triangular lower base comprises three members permanently affixed to one another in a triangular form

6. The tetrahedron-pyramid pile anchor guide according to claim 1, wherein the tetrahedron-pyramid shaped pile anchor guide further comprises mounting hardware removably affixed to the upper base plate, the mounting hardware configured to attach to a load bearing structure.

7. The tetrahedron-pyramid pile anchor guide according to claim 1, wherein the tetrahedron-pyramid shaped pile anchor guide further comprises removable hardware configured to secure a tubular anchor rod in a fixed position when the tubular anchor rod is driven into place within any one of the three tubulars of the pile anchor guide.

8. The tetrahedron-pyramid pile anchor guide according to claim 1, wherein the upper base plate is triangular.

9. The tetrahedron-pyramid pile anchor guide according to claim 1, the upper base plate, the triangular lower base, and the tubulars comprising a metal, plastic, or polymer material, and being substantially free of concrete or cement materials.

10. The tetrahedron-pyramid pile anchor guide according to claim 1, the triangular lower base being configured to lie substantially parallel with the ground during use, eliminating the need for extensive excavation.

11. The tetrahedron-pyramid pile anchor guide according to claim 1, wherein the fixed angles at which the tubulars are positioned between the upper and lower base range from about 20 degrees to about 80 degrees.

12. The tetrahedron-pyramid pile anchor guide according to claim 1, wherein the tubulars have a diameter in the range of about ¼ to 10 inches.

13. The tetrahedron-pyramid pile anchor guide according to claim 12, wherein the tubulars have a diameter of about 2 and ½ inches.

14. The tetrahedron-pyramid pile anchor guide according to claim 1, wherein the tubulars are configured to receive a tubular anchor rods, having diameter in the range of about ¼ to 10 inches and a length in the range of about 6 to 72 inches.

15. A pier anchoring structure kit, comprising:
a tetrahedron-pyramid pile anchor guide according to claim 1; and
three anchor rods adapted for insertion into the ground by force when positioned within the tubulars of the tetrahedron-pyramid pile anchor guide.

16. A structure having a foundation comprising:
a plurality of tetrahedron-pyramid shaped pile anchor guide anchor secured in a pattern on a building site by at least 3 tubular anchor rods per tetrahedron-pyramid shaped pile guide anchor as claimed in claim 1;
wherein the tubular anchor rods are secured in place once driven into the ground through the pile guide anchors by hardware; and
load bearing supports affixed to mounting hardware on each pile guide anchor.

17. A tetrahedron-pyramid shaped guide anchor to secure an item in a fixed yet removable position anchored to the Earth, comprising:
an upper base having an aperture therethrough;
a triangular lower base having an aperture therethrough;
three tubulars permanently affixed to the upper base and the lower base at fixed angles, thereby maintaining the upper base and lower base in fixed relative positions, each tubular configured to receive an anchor rod;
hardware affixed to the upper base configured to receive a portion of the item that is to be anchored to the Earth.

18. A tetrahedron-pyramid shaped guide anchor, wherein item is an umbrella or other shade structure.

19. A tetrahedron-pyramid shaped guide anchor, wherein item is a pet leash or tie-off.

20. A tetrahedron-pyramid shaped guide anchor, wherein item is electronic or photographic equipment.
